(19) United States
(12) Patent Application Publication
(10) Pub. No.: US 2015/0104966 A1
(43) Pub. Date: Apr. 16, 2015

(54) Method and Apparatus for Improving Connector Security and Device Coexistance

(71) Applicants: STMicroelectronics, Inc., Coppell, TX (US); Tatung Company, Taipei (TW)

(72) Inventors: Oleg Logvinov, East Brunswick, NJ (US); Tai-Jee Pan, Beaverton, OR (US)

(21) Appl. No.: 14/513,988

(22) Filed: Oct. 14, 2014

Related U.S. Application Data
(60) Provisional application No. 61/889,964, filed on Oct. 11, 2013.

(51) Int. Cl. H01R 13/621; H01R 43/26

(52) U.S. Cl. CPC H01R 13/621; H01R 43/26
USPC 439/345; 29/857

(57) ABSTRACT

Embodiments of the present disclosure include an apparatus and a method for connecting a first device and second device. An apparatus includes an angled connector configured to connect to a first device to a second device, the first device and the second device configured to communicate through signal paths in the connector, the signal paths configured to pass digital data signals, a fastening device configured to secure the angled connector to the first device.

### PRIORITY CLAIM AND CROSS-REFERENCE

This application claims the benefit of the following provisionally filed U.S. Patent application: Application Ser. No. 61/889,964, filed Oct. 11, 2013, and entitled “ Method and Apparatus for Improving Connector Security and Device Coexistance,” which application is hereby incorporated by reference.

### TECHNICAL FIELD

This invention relates generally to connecting devices, and more particularly to a method and apparatus for the coexistence of a second device plugged in to a connector on the first device and the physical security of the first and second devices.

### BACKGROUND

Electronic systems to day often contain many types of internal electronics. For example, a first device may contain one or more radio and wireless communications systems which work simultaneously, such as specified by IEEE 1905.1(TM)-2013 “Standard for a Convergent Digital Home Network for Heterogeneous Technologies.” The device may contain microprocessors which operate high clock rates and other high frequency circuits, for example, universal serial bus (USB) is a common communications technology that is currently capable of 4 Gbit/s and Gigabit Ethernet communication rate is capable of exceeding 1,000 Mbps, both of which are capable of high frequency signals and the noise they might create or propagate. The transistors and amplifiers in these systems typically support signal transitions of more than ten times the signaling rate, which is often ten times the clock rate or faster. This means that high frequency signals can be present in the circuits and interfaces for devices. Higher frequency noise can even be created as digital circuits switch through nonlinear transitions.

In some cases these high frequency signals and noise can interfere with a second device plugged into the first device or the second device may affect the first device. Thus, a solution is needed that can mitigate the potential for radiation from the devices.

### SUMMARY OF THE INVENTION

An apparatus includes an angled connector configured to connect to a first device to a second device, the first device and the second device configured to communicate through signal paths in the connector, the signal paths configured to pass digital data signals, a fastening device configured to secure the angled connector to the first device.

Another embodiment is an apparatus including an angled connector configured to connect to a first device to a second device, the first device and the second device configured to communicate through signal paths in the connector, the angled connector having a length to provide radio frequency isolation between the first and second devices, and a fastening device configured to secure the angled connector to the first device.

A further embodiment is a method for connecting a first device and second device, the method including connecting a first end of an angled connector to a first device, fastening the angled connector to the first device using a first fastening device, and connecting a second device to a second end of the angled connector, the angled connector configured to provide signal paths between the first and second devices, the angled connector having a length to provide radio frequency isolation between the first and second devices.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 illustrates an apparatus including a connector plugged into a device in accordance with an embodiment;

FIG. 2 illustrates the apparatus including the connector removed from the device in accordance with an embodiment; and

FIG. 3 illustrates a cross-sectional view of the apparatus including the connector plugged into the device in FIG. 1 in accordance with an embodiment.

Corresponding numerals and symbols in different figures generally refer to corresponding parts unless otherwise indicated. The figures are drawn to clearly illustrate the relevant aspects of embodiments of the present invention and are not necessarily drawn to scale. To more clearly illustrate certain embodiments, a letter indicating variations of the same structure, material, or process step may follow a figure number.

### DETAILED DESCRIPTION OF ILLUSTRATIVE EMBODIMENTS

The making and using of embodiments are discussed in detail below. It should be appreciated, however, that the present invention provides many applicable inventive concepts that may be embodied in a wide variety of specific contexts. The specific embodiments discussed are merely illustrative of specific ways to make and use the invention, and do not limit the scope of the invention.

The present disclosure will be described with respect to embodiments in a specific context, namely a method and apparatus for improving connector security and device coexistence. Embodiments of this invention may also be applied to other circuits and systems, such as, but not limited to, wireless systems such as wireless communication systems.

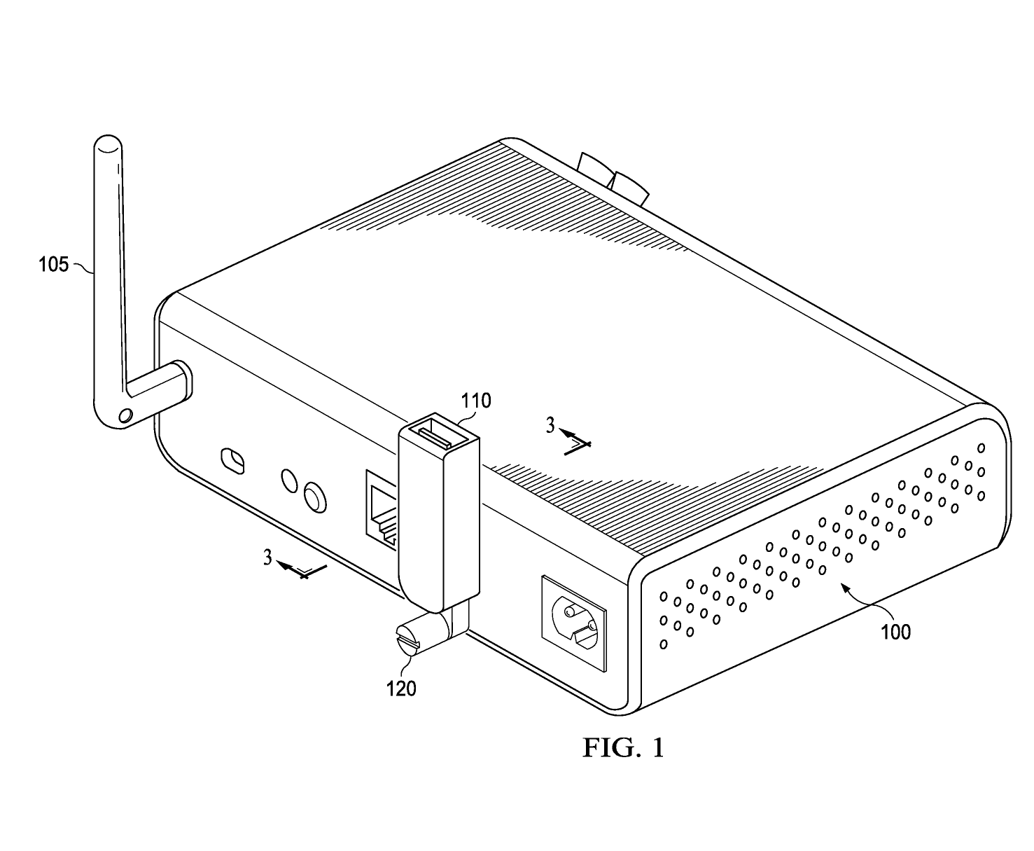

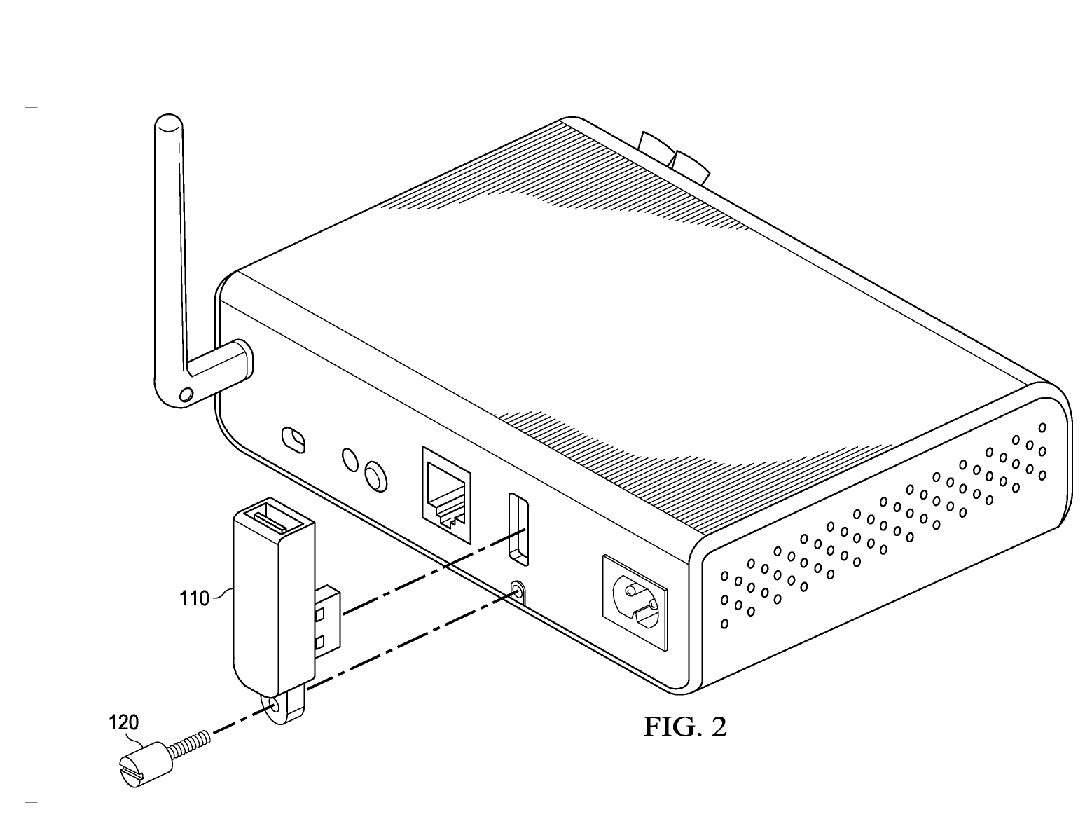

FIG. 1 illustrates a first end of an angled connector 110 is plugged into a first device 100 in accordance with an embodiment. The angled connector 110 may be used to provide connectivity and support to a second device (not shown) that is plugged to a second end of the angled connector 110. FIG. 2 illustrates the first end of an angled connector 110 is unplugged form the first device 100 in accordance with an embodiment. In an embodiment, the angled connector 110 is “L-shaped” and/or substantially forms a right angle (i.e. a 90° angle). The first device 100 may include an antenna 105 to transmit and receive Radio Frequency (RF) signals.

In some embodiments, the function of the second device is as a radio transceiver composed of at least a radio and an antenna. The function of an antenna is to match the radio transmit and receive interface impedance to the 377 ohm free space impedance which allows the RF signal to effectively propagate. Successful propagation could interfere with susceptible circuits in the first device 100 or be received by other antennae. At close ranges, the first device's 100 radio frequency does not have to be the same as the frequencies used by the other radios to interfere with the first device 100. It may be close enough such that spurious or noise energy could affect the first device's 100 receiver's amplifiers and/or detectors. Physical separation, orthogonal orientation of the electromagnetic fields, and directional antenna design may help to prevent the devices from interfering with each other. At high frequencies, distances of inches are enough to prevent coexistence or co-location issues.

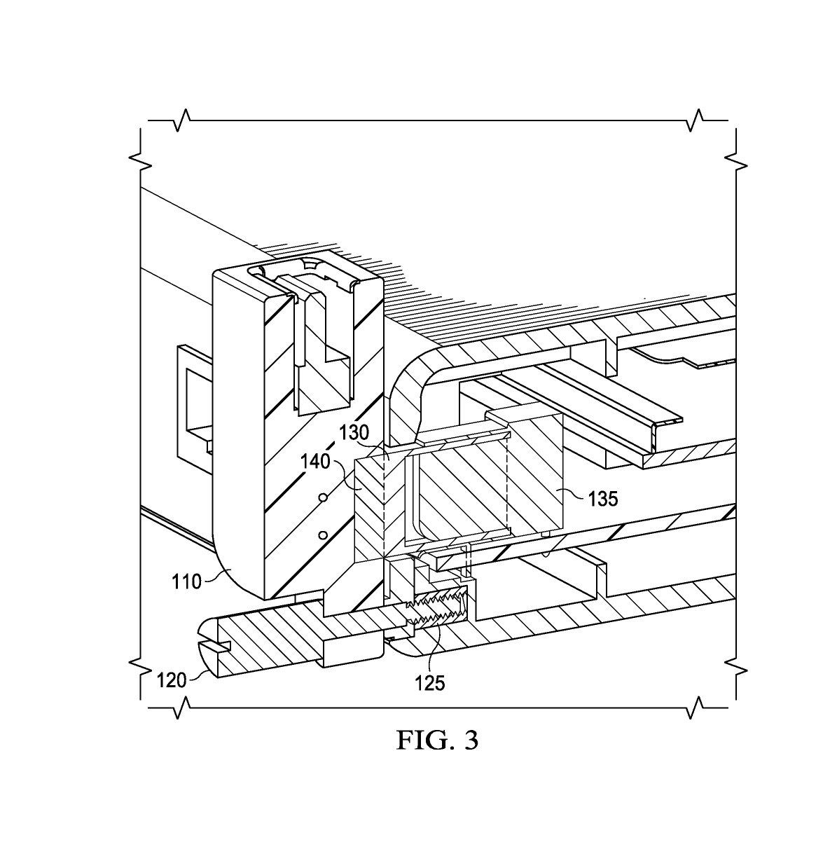

In some embodiments, it is also important that the angled connector 110 be a strong and stable connector. This is important because the second device may be suspended at a distance away from the first device 100, and thus, the angled connector 110 may effectively become a lever for the second device to apply a torque to the first device 100 and specifically the first device's connector 135 (see FIG. 3).

In some embodiments, shielding the noise at the source (the first device 100 and/or the second device) may be effective to allow the devices to coexist without either of the devices affecting the performance of the other device. However, in some embodiments, for example, connectors that are located on the edge of a printed circuit board (PCB) or where the interfaces carry high frequency signals, more protection than shielding may be needed.

In addition, when a first device contains one or more radios or radio technologies such as Wi-Fi (IEEE 802.11 technology), Bluetooth technology, Zigbee (IEEE 802.15.4) technology, adding additional radios may cause interference. If it becomes necessary to add an additional radio device (receiver, transmitter or transceiver) the shield of the first device 100 may not be sufficient, at small distances, to isolate the second device from noise or intentional transmissions.

FIG. 3 illustrates a cross-sectional view of an apparatus including the angled connector 110 plugged into the first device 100 in accordance with an embodiment. Signals from the first device 100 are presented to the signal conductors 130 in the first device's connector(s) 135. In an embodiment, the conductors 130 of the angled connector 100 is include at least one differential pair of wires configured to pass digital data signals between the first device 100 and the second device. The conductors 130 connect to the receiving pins 140 located in the angled connector 110.

In an embodiment, the dominant radiation aperture of the first device's connector 135 is the diagonal dimension of the connector 135 in the first device 100. In some embodiments, this dominant radiation aperture is inside the shielding of the connector 135 inside the first device 100. That dimension is continued inside the angled connector 110, but, in some embodiments, is reduced as much as possible in height and width. The signal conductors 130 pass through the angled connector 110 in a way that makes the largest effective aperture of the signal conductors 130 orthogonal to that of the first device's 100 aperture. This configuration of the signal conductors 130 reduces the interference between the first device 100 and the second device.

The effective aperture size of a USB port, for example, is about 16.5 mm, which is one wavelength of about 18.2 GHz. The quarter wavelength radiating element for this frequency is about 4.55 GHz. A common rule of thumb for radio emissions from an aperture is that significant energy can be radiated down to 1/20th of the wavelength, or, in this example, down to about 910 MHz. Hence, the signals found in the first device 100 may have frequencies in the range that may propagate through the opening of the connector 135. The propagation may be in either direction, from the first device 100 to the second device or from the second device to the first device 100. If more interfaces are available, multiple radiation paths are possible. In some cases these signals can interfere with the second device plugged into the angled connector 110 or the second device may affect the first device 100.

In some embodiments, the new technology of the present disclosure could be added within the first device's 100 case/shield and the antenna 105 could be located externally to separate the antenna(s) 105 from the noise or co-location issues. In some embodiments, it is not possible to integrate the second devices radio into the first device 100 case using a transmission line such as a coaxial line for physical separation due to regulations that restrict access to some connectors, such as those in the Industrial, Scientific, and Medical (ISM) radio bands. Moreover, adding radios within the first device's 100 case may require significant product redesign and/or regulatory approvals.

Hence, the angled connector 110 provides the flexibility to physically separate the first and second devices and to change their orientation, thereby addressing the means to mitigate interference, and improve mutual coexistence. The height (vertical height in FIG. 3) of the angled connector 110 is made long enough to physically isolate the second device which is plugged into its top, from the first device 100. At high frequencies that are used in today's components, distances of less than a two inches can resolve interference issues. The angled connector 110 may also be oriented to minimize exposure to RF noise or interaction with the antenna 105.

In order to secure the devices with respect to each other, a fastening device 120 firmly attaches the angled connector 110 to the first device 100. In an embodiment, the fastening device 120 is a screw, a holding clip, a pin, a clamping device, a hook, the like, or any other suitable fastening device. The fastening device 120 may be located anywhere that does not affect the signal or shielding integrity. The fastening device 120 also allows the second device to be secured to it. For example, the fastening device 120 may be internally or externally tapped to accept another screw from the second device. This arrangement not only address the devices mutual security but can also lock in the physical relationship between (orientation) the devices which is important to coexistence as previously presented.

In an embodiment, the connector is USB and its signals are conducted coaxially through the angled connector 110 so that the signal is as shielded as much as possible from a coverage perspective but still within the capacitance specification for the connector. In an embodiment, the standard USB connector as shown in FIGS. 2 and 3 is preferred because of its physical robustness. In another embodiment, a micro-USB connector, a mini-USB connector, the like, or a combination thereof may be used to reduce the overall physical space required.

In another embodiment, the signals are additionally conducted in coaxial cables.

In another embodiment, the connector is not limited to vertical or horizontal male or female connections but a vertical connection is shown as the exemplary orientation. In an embodiment, the orientation of the connector is vertical to allow the connector to better support the weight of the second device.

In another embodiment, the fastening screw is fitted with additional internal or external threads so that the second device may be secured to it.

It will also be readily understood by those skilled in the art that materials and methods may be varied while remaining within the scope of the present invention. It is also appreciated that the present invention provides many applicable inventive concepts other than the specific contexts used to illustrate embodiments. Accordingly, the appended claims are intended to include within their scope such processes, machines, manufacture, compositions of matter, means, methods, or steps.

What is claimed is:

1. An apparatus comprising:
an angled connector configured to connect to a first device to a second device, the first device and the second device configured to communicate through signal paths in the connector, the signal paths configured to pass digital data signals; and
a fastening device configured to secure the angled connector to the first device.

2. The apparatus of claim 1, wherein the angled connector has a length to provide radio frequency isolation between the first and second devices.

3. The apparatus of claim 1, wherein the angled connector substantially forms a right angle.

4. The apparatus of claim 1, wherein the connector is a Universal Serial Bus (USB) connector.

5. The apparatus of claim 1, wherein the signal paths comprise conductive wires.

6. The apparatus of claim 1, wherein the signal paths comprise coaxial conductive wires.

7. The apparatus of claim 1, wherein the signal paths comprise conductive wires inserted through a metal portion to create a coaxial transmission line.

8. The apparatus of claim 1, wherein the angled connector further comprises shielding in the connector configured to isolate the second device from the first device.

9. The apparatus of claim 8, wherein the signal paths comprise coaxial conductive wires passing through the shielding in the connector.

10. The apparatus of claim 1, wherein the fastening device comprises a screw, a holding clip, a pin, a clamping device, a hook, or a combination thereof.

11. An apparatus comprising:
an angled connector configured to connect to a first device to a second device, the first device and the second device configured to communicate through signal paths in the connector, the angled connector having a length to provide radio frequency isolation between the first and second devices; and
a fastening device configured to secure the angled connector to the first device.

12. The apparatus of claim 11, wherein the angled connector substantially forms a right angle.

13. The apparatus of claim 11, wherein the connector is a Universal Serial Bus (USB) connector.

14. The apparatus of claim 11, wherein the signal paths comprise coaxial conductive wires.

15. The apparatus of claim 11, wherein the signal paths comprise conductive wires inserted through a metal portion to create a coaxial transmission line.

16. The apparatus of claim 11, wherein the angled connector further comprises shielding in the connector configured to isolate the second device from the first device.

17. The apparatus of claim 11, wherein the fastening device comprises a screw, a holding clip, a pin, a clamping device, a hook, or a combination thereof.

18. A method for connecting a first device and second device, the method comprising:
connecting a first end of an angled connector to a first device;
fastening the angled connector to the first device using a first fastening device; and
connecting a second device to a second end of the angled connector, the angled connector configured to provide signal paths between the first and second devices, the angled connector having a length to provide radio frequency isolation between the first and second devices.

19. The method of claim 18, further comprising:
fastening the second device to the angled connector using a second fastening device.

20. The method of claim 19, wherein the second fastening device is configured to fasten to the first fastening device.

21. The method of claim 18, wherein the angled connector substantially forms a right angle.

22. The method of claim 18, wherein the connector is a Universal Serial Bus (USB) connector.

23. The method of claim 18, wherein the signal paths comprise conductive wires.

24. The method of claim 18, wherein the signal paths comprise coaxial conductive wires.

25. The method of claim 18, wherein the signal paths comprise conductive wires inserted through a metal portion to create a coaxial transmission line.

26. The method of claim 18, wherein the angled connector further comprises shielding in the connector configured to isolate the second device from the first device.

27. The method of claim 18, wherein the signal paths comprise coaxial conductive wires passing through the shielding in the connector.

28. The method of claim 18, wherein the first fastening device comprises a screw, a holding clip, a pin, a clamping device, a hook, or a combination thereof.
